(19) United States
(12) Patent Application Publication
(10) Pub. No.: US 2020/0236882 A1
(43) Pub. Date: Jul. 30, 2020

(54) SYSTEMS AND METHODS FOR GERMINATING SEEDS

(71) Applicant: Grow Solutions Tech LLC, Vineyard, UT (US)

(72) Inventors: Scott Nielson, Pleasant Grove, UT (US); Jessica Smith, Spanish Fork, UT (US); Jordan Farnsworth Smith, Spanish Fork, UT (US)

(73) Assignee: Grow Solutions Tech LLC, Vineyard, UT (US)

(21) Appl. No.: 16/263,523

(22) Filed: Jan. 31, 2019

Related U.S. Application Data
(63) Continuation of application No. PCT/US19/15762, filed on Jan. 30, 2019.

(51) Int. Cl. A01G 31/04; A23K 10/30

(52) U.S. Cl. CPC A01G 31/042; A23K 10/30

(57) ABSTRACT

A system for germinating seeds according to a germination recipe is disclosed. The system for germinating seeds for a grow pod includes a plurality of germination sub-tanks configured to receive seeds, the plurality of germination sub-tanks receiving different species of seeds, respectively, a master germination tank configured to receive seeds from one or more of the plurality of germination sub-tanks, and a controller. The controller includes one or more processors, one or more memory modules storing germination recipes, and machine readable instructions stored in the one or more memory modules that, when executed by the one or more processors, cause the controller to: determine a ratio of the different species of seeds based on a germination recipe, operate the plurality of germination sub-tanks to provide seeds to the master germination tank based on the ratio, and provide the seeds in the master germination tank to one or more carts.

### CROSS-REFERENCE TO RELATED APPLICATION

This application is a continuation of International Patent Application No. PCT/US19/15762 filed on Jan. 30, 2019, the entire contents of which are incorporated herein by reference.

### TECHNICAL FIELD

Embodiments described herein generally relate to systems and methods for germinating seeds and, more specifically, to germinating different species of seeds based on germination recipes.

### BACKGROUND

While crop growth technologies have advanced over the years, there are still many problems in the farming and crop industry today. As an example, while technological advances have increased efficiency and production of various crops, many factors may affect a harvest, such as weather, disease, infestation, and the like. Additionally, while the some countries currently have suitable farmland to adequately provide food for their population, other countries and future populations may not have enough farmland to provide the appropriate amount of food.

Various feed including peas, barleys, wheats, etc. may be provided to animals. However, each animal may need different nutrition depending on its health, production cycle, age, etc. Thus, systems for growing feed that has customized nutrition levels may be needed.

### SUMMARY

In one embodiment, a system for germinating seeds according to a germination recipe is disclosed. The system for germinating seeds for a grow pod includes a plurality of germination sub-tanks configured to receive seeds, the plurality of germination sub-tanks receiving different species of seeds, respectively, a master germination tank configured to receive seeds from one or more of the plurality of germination sub-tanks, and a controller. The controller includes one or more processors, one or more memory modules storing germination recipes, and machine readable instructions stored in the one or more memory modules that, when executed by the one or more processors, cause the controller to: determine a ratio of the different species of seeds based on a germination recipe, operate the plurality of germination sub-tanks to provide seeds to the master germination tank based on the ratio, and provide the seeds in the master germination tank to one or more carts.

In another embodiment, a controller for germinating seeds for a grow pod is provided. The controller includes one or more processors, one or more memory modules storing germination recipes, and machine readable instructions stored in the one or more memory modules that, when executed by the one or more processors, cause the controller to: determine a ratio of the different species of seeds based on a germination recipe; operate a plurality of germination sub-tanks to provide seeds to a master germination tank based on the ratio; and provide the seeds in the master germination tank to one or more carts. The plurality of germination sub-tanks receive different species of seeds, respectively.

In another embodiment, a method for germinating seeds for a grow pod is provided. The method includes providing different species of seeds to a plurality of germination sub-tanks, respectively, determining a ratio of the different species of seeds based on a germination recipe, operating the plurality of germination sub-tanks to provide the different species of seeds to a master germination tank based on the ratio, and providing the seeds in the master germination tank to one or more carts.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts an assembly line grow pod, according to embodiments described herein;

FIG. 2 depicts a germination system, according to one or more embodiments shown and described herein;

FIG. 3 depicts a computing environment for an assembly line grow pod, according to embodiments described herein;

FIG. 4 depicts determining a germination recipe based on production cycle of animals, according to one or more embodiments shown and described herein;

FIG. 5 depicts a graph showing an exemplary production cycle of livestock, according to one or more embodiments shown and described herein;

FIG. 6 depicts operating a plurality of assembly line grow pods according to germination recipes determined based on information about status of animals, according to one or more embodiments shown and described herein;

FIG. 7 depicts a flowchart for germinating seeds, according to embodiments described herein; and

FIG. 8 depicts a computing device for an assembly line grow pod, according to embodiments described herein.

### DETAILED DESCRIPTION

Embodiments disclosed herein include systems and methods for germinating seeds for an assembly line grow pod according to germination recipes. A system for germinating seeds for a grow pod includes a plurality of germination sub-tanks configured to receive seeds, the plurality of germination sub-tanks receiving different species of seeds, respectively, a master germination tank configured to receive seeds from one or more of the plurality of germination sub-tanks, and a controller. The controller includes one or more processors, one or more memory modules storing germination recipes, and machine readable instructions stored in the one or more memory modules that, when executed by the one or more processors, cause the controller to: determine a ratio of the different species of seeds based on a germination recipe, operate the plurality of germination sub-tanks to provide seeds to the master germination tank based on the ratio, and provide the seeds in the master germination tank to one or more carts. These embodiments produce plants having customized nutrition levels based on germination recipes. The germination recipe may be determined based on required nutrition levels input by a user or information about status of animals to feed. The germination recipe may be implemented strictly and/or modified based on results of a particular plant, tray, or crop. The systems and methods for germinating seeds for a grow pod incorporating the same will be described in more detail, below.

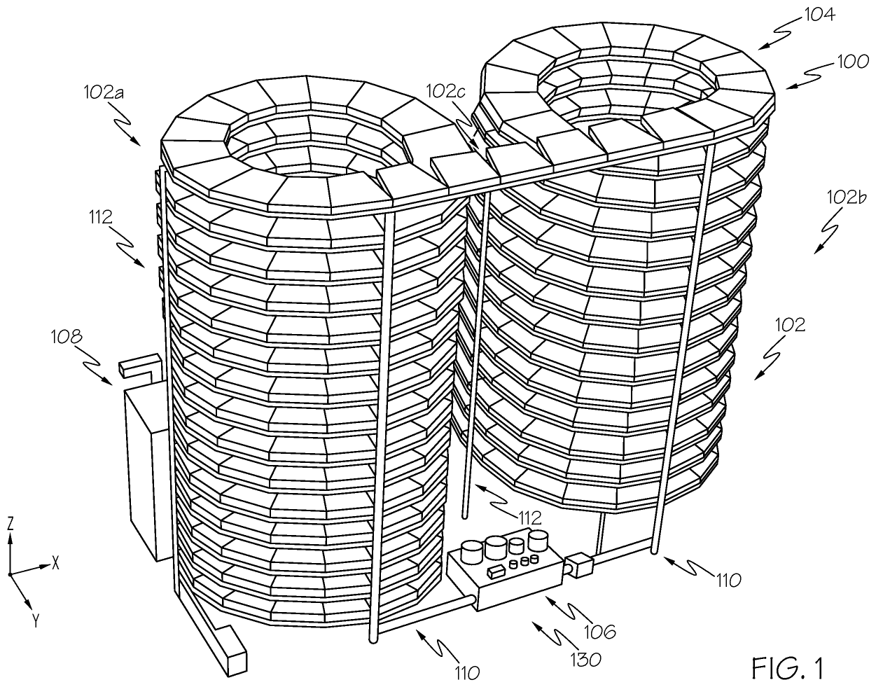

Referring now to the drawings, FIG. 1 depicts an assembly line grow pod 100 that receives a plurality of industrial carts 104, according to embodiments described herein. The assembly line grow pod 100 may be positioned on an x-y plane as shown in FIG. 1. As illustrated, the assembly line grow pod 100 may include a track 102 that holds one or more industrial carts 104. Each of the one or more industrial carts 104 may include one or more wheels rotatably coupled to the industrial cart 104 and supported on the track 102.

Additionally, a drive motor is coupled to the industrial cart 104. In some embodiments, the drive motor may be coupled to at least one of the one or more wheels may be propelled along the track 102 in response to a signal transmitted to the drive motor. In other embodiments, the drive motor may be rotatably coupled to the track 102. For example, without limitation, the drive motor may be rotatably coupled to the track 102 through one or more gears which engage a plurality of teeth arranged along the track 102 such that the industrial cart 104 may be propelled along the track 102.

The track 102 may consist of a plurality of modular track sections. The plurality of modular track sections may include a plurality of straight modular track sections and a plurality of curved modular track sections. The track 102 may include an ascending portion 102a, a descending portion 102b, and a connection portion 102c. The ascending portion 102a and the descending portion 102b may include the plurality of curved modular track sections. The ascending portion 102a may wrap around (e.g., in a counterclockwise direction as depicted in FIG. 1) a first axis such that the industrial carts 104 ascend upward in a vertical direction. The first axis may be parallel to the z axis as shown in FIG. 1 (i.e., perpendicular to the x-y plane). The plurality of curved modular track sections of the ascending portion 102a may be tilted relative to the x-y plane (i.e., the ground) by a predetermined angle.

The descending portion 102b may be wrapped around a second axis (e.g., in a counterclockwise direction as depicted in FIG. 1) that is substantially parallel to the first axis, such that the industrial carts 104 may be returned closer to ground level. The plurality of curved modular track sections of the descending portion 102b may be tilted relative to the x-y plane (i.e., the ground) by a predetermined angle.

The connection portion 102c may include a plurality of straight modular track sections. The connection portion 102c may be relatively level with respect to the x-y plane (although this is not a requirement) and is utilized to transfer the industrial carts 104 from the ascending portion 102a to the descending portion 102b. In some embodiments, a second connection portion (not shown in FIG. 1) may be positioned near ground level that couples the descending portion 102b to the ascending portion 102a such that the industrial carts 104 may be transferred from the descending portion 102b to the ascending portion 102a. The second connection portion may include a plurality of straight modular track sections.

In some embodiments, the track 102 may include two or more parallel rails that support the industrial cart 104 via the one or more wheels of the industrial cart rotatably coupled thereto. In some embodiments, at least two of the parallel rails of the track 102 are electrically conductive, thus capable of transmitting communication signals and/or power to and from the industrial cart 104. In yet other embodiments, a portion of the track 102 is electrically conductive and a portion of the one or more wheels of the industrial cart are in electrical contact with the portion of the track 102 which is electrically conductive. In some embodiments, the track 102 may be segmented into more than one electrical circuit. That is, the electrically conductive portion of the track 102 may be segmented with a non-conductive section such that a first electrically conductive portion of the track 102 is electrically isolated from a second electrically conductive portion of the track 102 which is adjacent to the first electrically conductive portion of the track 102. It may take about 144 hours to 168 hours for the industrial cart 104 to go through the entire track 102.

The communication signals and power may further be received and/or transmitted via the one or more wheels of the industrial cart 104 and to and from various components of industrial cart 104, as described in more detail herein. Various components of the industrial cart 104, as described in more detail herein, may include the drive motor, the control device, and one or more sensors.

In some embodiments, the communication signals and power signals may include an encoded address specific to an industrial cart 104 and each industrial cart 104 may include a unique address such that multiple communication signals and power may be transmitted over the same track 102 and received and/or executed by their intended recipient. For example, the assembly line grow pod 100 system may implement a digital command control system (DCC). DDC systems encode a digital packet having a command and an address of an intended recipient, for example, in the form of a pulse width modulated signal that is transmitted along with power to the track 102.

In such a system, each industrial cart 104 includes a decoder, which may be the control device coupled to the industrial cart 104, designated with a unique address. When the decoder receives a digital packet corresponding to its unique address, the decoder executes the embedded command. In some embodiments, the industrial cart 104 may also include an encoder, which may be the control device coupled to the industrial cart 104, for generating and transmitting communications signals from the industrial cart 104, thereby enabling the industrial cart 104 to communicate with other industrial carts 104 positioned along the track 102 and/or other systems or computing devices communicatively coupled with the track 102.

While the implementation of a DCC system is disclosed herein as an example of providing communication signals along with power to a designated recipient along a common interface (e.g., the track 102) any system and method capable of transmitting communication signals along with power to and from a specified recipient may be implemented. For example, in some embodiments, digital data may be transmitted over AC circuits by utilizing a zero-cross, step, and/or other communication protocol.

Additionally, while not explicitly illustrated in FIG. 1, the assembly line grow pod 100 may also include a harvesting component, a tray washing component, and other systems and components coupled to and/or in-line with the track 102. In some embodiments, the assembly line grow pod 100 may include a plurality of lighting devices, such as light emitting diodes (LEDs). The lighting devices may be disposed on the track 102 opposite the industrial carts 104, such that the lighting devices direct light waves to the industrial carts 104 on the portion the track 102 directly below. In some embodiments, the lighting devices are configured to create a plurality of different colors and/or wavelengths of light, depending on the application, the type of plant being grown, and/or other factors. Each of the plurality of lighting devices may include a unique address such that a master controller 106 may communicate with each of the plurality of lighting devices. While in some embodiments, LEDs are utilized for this purpose, this is not a requirement. Any lighting device that produces low heat and provides the desired functionality may be utilized.

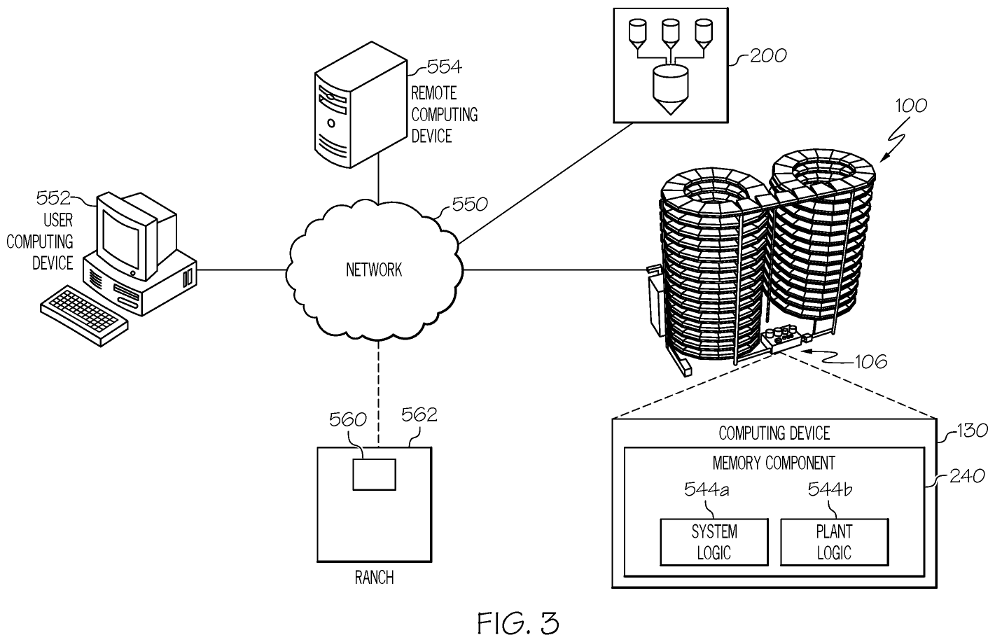

Also depicted in FIG. 1 is a master controller 106. The master controller 106 may include a computing device 130, a nutrient dosing component, a water distribution component, and/or other hardware for controlling various components of the assembly line grow pod 100. In some embodiments, the master controller 106 and/or the computing device 130 are communicatively coupled to a network 550 (as depicted and further described with reference to FIG. 3). The master controller 106 may control operations of germinating seeds based on germination recipes, which will be described in detail below.

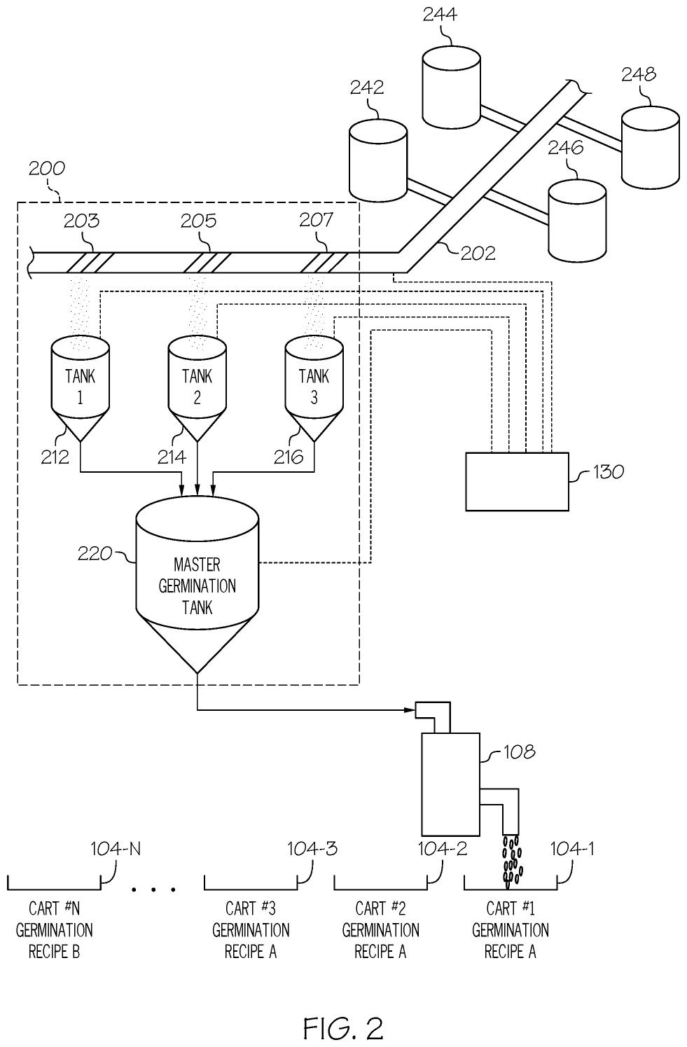

Coupled to the master controller 106 is a seeder component 108. The seeder component 108 may be configured to seed one or more industrial carts 104 as the industrial carts 104 pass the seeder in the assembly line. The seeder component 108 may receive seeds from a master germination tank 220 (as depicted and further described with reference to FIG. 2). Depending on the particular embodiment, each industrial cart 104 may include a single section tray for receiving a plurality of seeds. Some embodiments may include a multiple section tray for receiving individual seeds in each section (or cell). In the embodiments with a single section tray, the seeder component 108 may detect presence of the respective industrial cart 104 and may begin laying seed across an area of the single section tray. The seed may be laid out according to a desired depth of seed, a desired number of seeds, a desired surface area of seeds, and/or according to other criteria. In some embodiments, the seeds may be pre-treated with nutrients and/or anti-buoyancy agents (such as water) as these embodiments may not utilize soil to grow the seeds and thus might need to be submerged.

In the embodiments where a multiple section tray is utilized with one or more of the industrial carts 104, the seeder component 108 may be configured to individually insert seeds into one or more of the sections of the tray. Again, the seeds may be distributed on the tray (or into individual cells) according to a desired number of seeds, a desired area the seeds should cover, a desired depth of seeds, etc. In some embodiments, the seeder component 108 may communicate the identification of the seeds being distributed to the master controller 106.

The watering component may be coupled to one or more water lines 110, which distribute water and/or nutrients to one or more trays at predetermined areas of the assembly line grow pod 100. In some embodiments, seeds may be sprayed to reduce buoyancy and then flooded. Additionally, water usage and consumption may be monitored, such that at subsequent watering stations, this data may be utilized to determine an amount of water to apply to a seed at that time.

Also depicted in FIG. 1 are airflow lines 112. Specifically, the master controller 106 may include and/or be coupled to one or more components that delivers airflow for temperature control, humidity control, pressure control, carbon dioxide control, oxygen control, nitrogen control, etc. Accordingly, the airflow lines 112 may distribute the airflow at predetermined areas in the assembly line grow pod 100.

It should be understood that while some embodiments of the track may be configured for use with a grow pod, such as that depicted in FIG. 1, this is merely an example. The track and track communications are not so limited and can be utilized for any track system where communication is desired.

FIG. 2 depicts a germination system 200, according to one or more embodiments shown and described herein. The germination system 200 includes a conveyor 202, a plurality of silos 242, 244, 246, and 248, a plurality of germination sub-tanks 212, 214, and 216, and a master germination tank 220.

The plurality of silos 242, 244, 246, and 248 may store different species of seeds. For example, the silo 242 may store wheat seeds, the silo 244 may store pea seeds, the silo 246 may store barley seeds, and the silo 248 may store clover seeds. Each of the plurality of silos 242, 244, 246 and 248 is connected to conveyor 202 such that seeds from the plurality of silos 242, 244, 246, and 248 are provided to the conveyor 202. While FIG. 2 depicts four silos, the number of silos may be greater than four or less than four.

The conveyor 202 carries seeds from the plurality of silos 242, 244, 246, and 248. The conveyor 202 may include movable plates 203, 205, and 207. Each of the movable plates 203, 205, and 207 may be in an open position or in a closed position. The movable plates 203, 205, and 207 may be positioned over the germination sub-tanks 212, 214, and 216, respectively. While FIG. 2 depicts three movable plates, the germination system 200 may include more than or less than three movable plates. When the movable plate is in a closed position, the conveyor 202 continues to carry the seeds. When the movable plate is in an open position, the seeds on the conveyor may be poured into one of the germination sub-tanks 212, 214, and 216. For example, when the movable plate 207 is in an open position, the seeds on the conveyor 202 are poured into the germination sub-tank 216. As another example, when the movable plate 205 is in an open position, the seeds on the conveyor 202 are poured into the germination sub-tank 214. As another example, when the movable plate 203 is in an open position, the seeds on the conveyor 202 are poured into the germination sub-tank 212. In some embodiments, the conveyor 202 may include bypass routes instead of the movable plates. Each of the bypass routes may bypass the seeds on the conveyor 202 to one of the germination sub-tanks 212, 214, and 216.

The germination sub-tanks 212, 214, and 216 may contain water and receive seeds from the conveyor 202. Each of the germination sub-tanks 212, 214, and 216 may be connected to a water pump configured to provide water to the germination sub-tanks 212, 214, and 216. Each of the germination sub-tanks 212, 214, and 216 may include a water temperature sensor, and a water heater/cooler. Each of the germination sub-tanks 212, 214, and 216 may monitor the temperature of water in the sub-tank using the water temperature sensor and maintain the temperature of water in the sub-tank at a certain temperature by operating the water heater/cooler. Each of the germination sub-tanks 212, 214, and 216 may include a draining pipe. After the seeds are soaked in the germination tank for a predetermined time, each of the germination sub-tanks may drain water through the draining pipe before delivering the seeds to the master germination tank 220.

The master germination tank 220 may receive different species of seeds from the germination sub-tanks 212, 214, and 216. The master germination tank 220 may mix the received seeds by providing air and water into the master germination tank 220. After the mixed seeds are retained in the master germination tank 220 for a predetermined time, the master germination tank 220 provides the mixed seeds to the seeder component 108. Then, the seeder component 108 provides the mixed seeds to each of the industrial carts 104.

The computing device 130 may control the operations of the conveyor 202, the germination sub-tanks 212, 214, and 216, and the master germination tank 220 based on a germination recipe. The germination recipe may include nutrition levels, a ratio of different species of seeds, germination time for each of the different species, water temperature, etc. For example, germination recipes may include information as in table 1.

TABLE 1

| | | | Seed Soaking | Water |
|---|---|---|---|---|
| Recipe | Nutrition Levels | Ratio | Time | temperature |
| Recipe A | Fiber 15% | Barley: 20% | Barley: 15 hours | Barley: 50° F. |
| | Protein 31% | Pea: 50% | Peas: 11 hours | Peas: 55° F. |
| | Carbohydrates 5% | Wheat: 30% | Wheat: 8 hours | Wheat: 58° F. |
| Recipe B | Fiber 14% | Barley: 30% | Barley: 15 hours | Barley: 50° F. |
| | Protein 21% | Pea: 30% | Peas: 10 hours | Peas: 55° F. |
| | Carbohydrates 7% | Wheat: 40% | Wheat: 7 hours | Wheat: 58° F. |
| Recipe C | Fiber 9% | Barley: 10% | Barley: 13 hours | Barley: 50° F. |
| | Protein 45% | Pea: 60% | Peas: 10 hours | Peas: 55° F. |
| | Carbohydrates 11% | Wheat: 30% | Wheat: 9 hours | Wheat: 58° F. |
| Recipe D | Fiber 21% | Barley: 40% | Barley: 14 hours | Barley: 50° F. |
| | Protein 15% | Pea: 20% | Peas: 12 hours | Peas: 55° F. |
| | Carbohydrates 21% | Wheat: 40% | Wheat: 9 hours | Wheat: 58° F. |

The computing device 130 may control the plurality of silos and the open/closed position of the movable plates 203, 205, and 207 based on the germination recipe. For example, if the germination recipe is Recipe A in Table 1 above, the computing device 130 may determine that barley seeds need to be soaked first, and determine that after four hours of soaking barley seeds, pea seeds need to be soaked. The computing device 130 may determine that after three hours of soaking pea seeds, wheat seeds need to be soaked. Thus, the computing device 130 may instruct a silo storing barley seeds to provide barley seeds to the conveyor 202, and operate the movable plate 203 in an open position, for example, at 12 pm. After providing barley seeds into the germination sub-tank 212, the computing device 130 may instruct a silo storing pea seeds to provide pea seeds to the conveyor 202, and operate the movable plate 205 in an open position, for example, at 4 pm. After providing pea seeds into the germination sub-tank 214, the computing device 130 may instruct a silo storing wheat seeds to provide wheat seeds to the conveyor 202, and operate the movable plate 207 in an open position, for example, at 7 pm.

The computing device 130 may control water temperature in each of the germination sub-tanks 212, 214, and 216 based on the germination recipe. For example, if the current germination recipe is Recipe A in Table 1, the computing device 130 controls the water heater/cooler to maintain the water temperatures of the germination sub-tanks 212, 214, and 216 to be 50° F., 55° F. and 58° F., respectively.

The computing device 130 may control the master germination tank 220 to provide mixed seed in the master germination tank 220 to the seeder component 108. For example, after mixed seeds are maintained in the master germination tank 220 for a certain time (e.g., several hours), the computing device 130 instructs the master germination tank 220 to provide the mixed seeds to the seeder component 108.

The seeder component 108 may provide the mixed seeds to industrial carts. Each of the industrial carts has unique identification, and the computing device 130 may store information about a germination recipe for the seeds provided in each of the industrial carts. For example, for the industrial carts 104-1, 104-2, and 104-3, the seeder component 108 may provide mixed seeds germinated according to Recipe A. According to Recipe A, plants grown in the industrial carts 104-1, 104-2, and 104-3 may have 15% of fiber and 31% of protein. The plants in the industrial carts 104-1, 104-2 and 104-3 may be harvested by the harvesting component of the assembly line grow pod 100 and stored in a container. Information about the nutrition levels included in Recipe A may be added to the container.

If the germination recipe is changed from Recipe A to Recipe B, then the computing device 130 operates the movable plates 203, 205, and 207, the germination sub-tanks 212, 214, and 216, and the master germination tank 220 according to Recipe B. Then, the seeder component 108 provides mixed seeds germinated according to Recipe B to industrial carts. For example, the industrial cart 104-N receives mixed seeds germinated according to Recipe B. According to Recipe B, plants grown in the industrial cart 104-N may have 14% of fiber and 21% of protein. The plants in the industrial cart 104-N may be harvested by the harvesting component of the assembly line grow pod 100 and stored in a container. Information about the nutrition levels included in Recipe B may be added to the container. Thus, according to the present disclosure, the assembly line grow pod 100 may produce plants having customized nutrition levels based on germination recipes.

While the above embodiments describe providing geminated seeds according to germination recipes to industrial carts moving in the assembly line grow pod 100, the germination system 200 may provide germinated seeds according to the germination recipe to a different system. For example, the germination system 200 may provide germinated seeds to stationary grow pods instead of moving carts. As another example, the germination system 200 may provide the germinated seeds to other types of greenhouses and/or other grow apparatuses.

FIG. 3 depicts a computing environment for an assembly line grow pod 100, according to embodiments described herein. As illustrated, the assembly line grow pod 100 may include a master controller 106, which may include a computing device 130. The computing device 130 may include a memory component 540, which stores systems logic 544a and plant logic 544b. As described in more detail below, the systems logic 544a may monitor and control operations of one or more of the components of the assembly line grow pod 100. The plant logic 544b may be configured to determine and/or receive a germination recipe for plant growth and may facilitate implementation of the germination recipe via the systems logic 544a.

Additionally, the assembly line grow pod 100 is coupled to a network 550. The network 550 may include the internet or other wide area network, a local network, such as a local area network, a near field network, such as Bluetooth or a near field communication (NFC) network. The network 550 is also coupled to a user computing device 552, a remote computing device 554, the germination system 200, and a computing device 560 at a ranch 562. The user computing device 552 may include a personal computer, laptop, mobile device, tablet, server, etc. and may be utilized as an interface with a user. As an example, a user may input a germination recipe to the computing device 130 for implementation by the assembly line grow pod 100. For example, the user computing device 552 may show a plurality of germination recipes in association nutrition levels. A user may select one of the germination recipes based on nutrition levels. For example, a user who wants feed having a high protein level, he or she may select Recipe C among the recipes in Table 1 above. Then, the user computing device 552 sends the selected Recipe C to the computing device 130. The computing device 130 operates the movable plates 203, 205, and 207, the germination sub-tanks 212, 214, and 216, and the master germination tank 220 according to Recipe C.

Similarly, the remote computing device 554 may include a server, personal computer, tablet, mobile device, etc. and may be utilized for machine to machine communications. As an example, if the assembly line grow pod 100 determines a type of seed being used (and/or other information, such as ambient conditions), the computing device 130 may communicate with the remote computing device 554 to retrieve a previously stored recipe for those conditions. As such, some embodiments may utilize an application program interface (API) to facilitate this or other computer-to-computer communications.

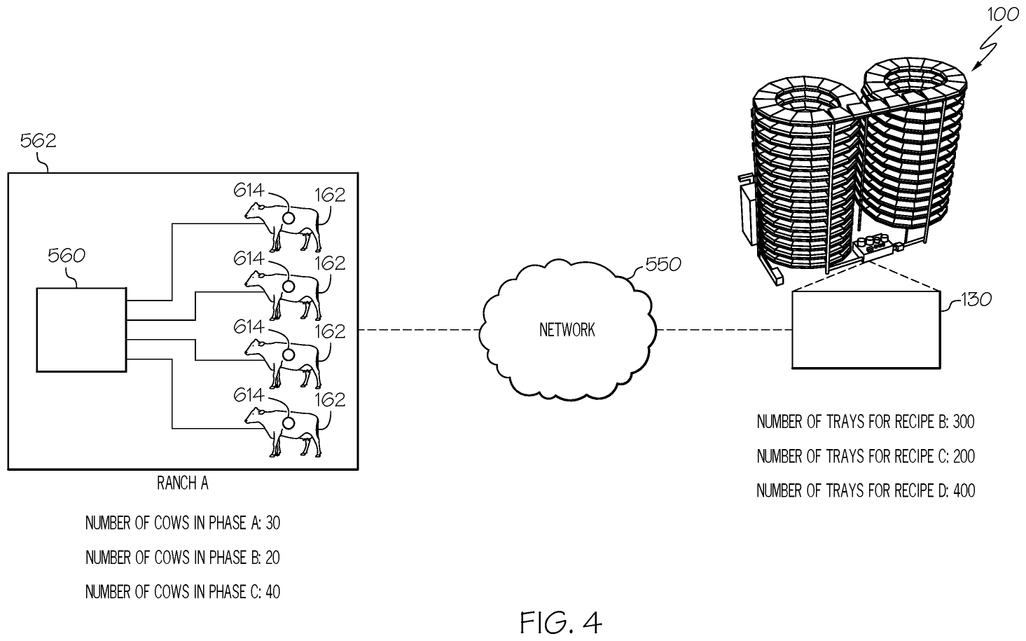

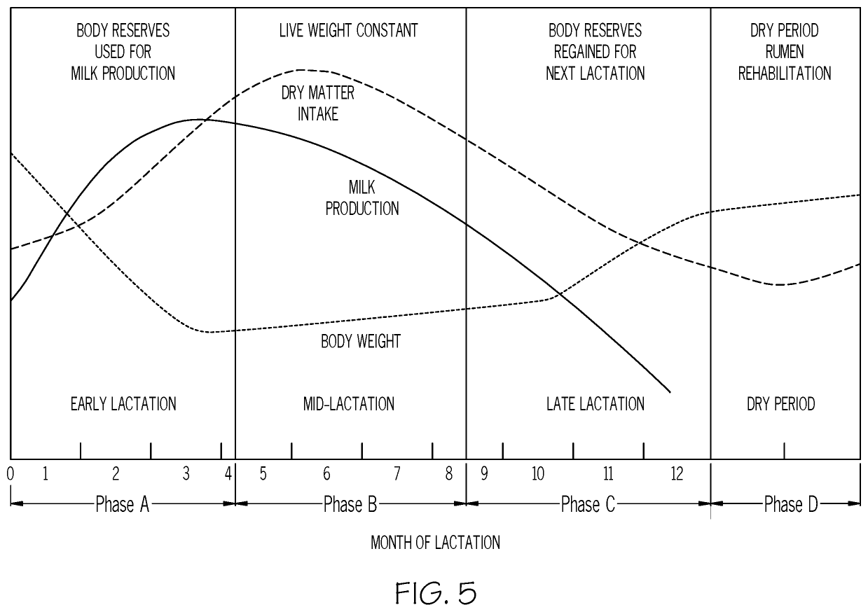

The computing device 560 for the ranch 562 may include a personal computer, laptop, mobile device, tablet, server, etc. and may be utilized as an interface with a user. The computing device 560 may collect information about status of animals in the ranch 562. The computing device 130 receives information about status of animals in the ranch and determines a germination recipe based on the status of the animals in the ranch. Details about the information about status of animals and determining a germination recipe will be described in detail with reference to FIGS. 4 and 5 below.

FIG. 4 depicts determining a germination recipe based on production cycle of animals, according to one or more embodiments shown and described herein. A plurality of animals (e.g., cows) 612 are in the ranch 562. A monitoring device 614 may be attached to each of the animals 612. The monitoring device 614 may monitor production cycle of the animals. For example, the monitoring device 614 may include sensors for measuring milk production per day. As another example, a person may input a current production cycle of the animal into the monitoring device 614. The monitoring devices 614 may wirelessly communicate with the computing device 560. The computing device 560 may collect information about the status of the animals 612 from the monitoring devices. Based on the received information, the computing device 560 may determine that, for example, 30 cows are in phase A, and 20 cows are in phase B, 40 cows are in phase C, and 0 cows in phase D.

Phases A, B, C, and D may be determined based on production cycle, for example, as shown in FIG. 5. As shown in FIG. 5, the cycle may be split into four phases, the early, mid and late lactation (each of about 120 days) and the dry period (which should last as long as 65). A number of changes occur in cows as they progress through different stages of lactation. As well as variations in milk production, there are changes in feed intake and body condition, and stage of pregnancy. FIG. 5 presents the interrelationships between feed intake, milk yield and live weight for a Friesian cow with a 14 month inter-calving interval.

During phase A, milk yield by a cow increases and peaks, and dry matter intake by the cow increases as well. During phase B, milk yield decreases, and dry matter intake peaks and then decreases. During phase C, both milk yield and dry matter intake decreases whereas body weight of the cow increases. During phase D, the cow does not product milk.

Each of the four phases is assigned a different germination recipe that is predetermined to maximize milk production. For example, Table 2 below shows correspondence among phases, nutrition levels, and germination recipes.

For example, Table 2 below shows correspondence among phases, nutrition levels, and germination recipes.

TABLE 2

| | Nutrition Levels to | |
|---|---|---|
| Phase | Maximize production | Germination Recipe |
| Phase A | Fiber 14% | Recipe B |
| | Protein 21% | |
| | Carbohydrates 7% | |
| Phase B | Fiber 9% | Recipe C |
| | Protein 45% | |
| | Carbohydrates 11% | |
| Phase C | Fiber 21% | Recipe D |
| | Protein 15% | |
| | Carbohydrates 21% | |
| Phase D | Fiber 15% | Recipe A |
| | Protein 31% | |
| | Carbohydrates 5% | |

For example, for Phase A, nutrition levels to maximize production (e.g., milk production) are 14% of fiber, 21% of protein, and 7% of carbohydrates. Then, the computing device 130 may choose germination recipe B that matches with the nutrition levels to produce feed for the animals in phase A. As another example, for Phase C, nutrition levels to maximize production (e.g., milk production) are 21% of fiber, 15% of protein, and 21% of carbohydrates. Then, the computing device 130 may choose germination recipe D to produce feed for the animals in phase C. Specifically, cows in phase C produce less milk compared to ones in phase A or B. Feed produced according to Recipe D has a high carbohydrates level that may boost milk production of cows in phase C.

The computing device 560 transmits information about the status of animals including phase information to the computing device 130 through the network 550. The computing device 130 may determine a germination recipe based on the information about the status of the animals. In embodiments, the computing device 130 may determine a germination recipe that maximizes milk product for corresponding phase of the production cycle. For example, for the cows in Phase A, the computing device 130 determines that feed grown per germination Recipe B enhances milk production of the cows in Phase A. Similarly, for the cows in Phase B, the computing device 130 determines that feed grown per germination Recipe C enhances milk production of the cows in Phase B. Similarly, for the cows in Phase C, the computing device 130 determines that feed grown per germination Recipe D enhances milk production of the cows in Phase C. Specifically, when cows are in a late lactation phase (Phase C), feed having high sugar level may boost milk production. Thus, feed grown according to germination Recipe D may have a high sugar level or high carbohydrates level.

In embodiments, the amount of feed to be produced according to certain recipe may be proportional to the number of animals in a certain phase. As shown in FIG. 4, the ratio of animals in phases A, B, and C is 3:2:4. Thus, the ratio of feed to be produced according to Recipes B, C and D may be 3:2:4. For example, the computing device 130 may determine that 300 industrial carts need to carry seeds germinated according to Recipe B, 200 industrial carts need to carry seeds germinated according to Recipe C, and 400 industrial carts need to carry seeds germinated according to Recipe D.

In some embodiments, a germination recipe may be determined based on whether cows produce products as desired or not. For example, milk production of a cow is compared with a predetermined amount, and the computing device 560 may collect information about whether the cows are producing products as desired or not. The computing device 560 may transmit the information to the computing device 130. The computing device may determine a germination recipe based on the information. For example, if the cows are producing products as desired, the computing device 130 may select a germination recipe that is set as a default. If the cows are not producing products as desired, the computing device 130 may select a germination recipe for seeds that may boost production of the cows.

In some embodiments, in the ranch, animals may be segregated based on desired products. The ranch 562 may be divided into a plurality of areas. Animals producing different products may reside in each of the areas, respectively. For example, cows producing milk may reside in area 1, cows producing cheese may reside in area 2, and cows producing cream may reside in area 3. The computing device 560 may transmit information about desired product along with information about status of cows in each of the areas to the computing device 130. The computing device 130 may determine a germination recipe based on the information about desired product and/or information about status of cows. For example, the computing device 130 may select germination Recipe B for the cows producing milk that are in phase A. The computing device 130 may select germination Recipe Y for the cows producing cheese. Recipe Y may be predetermined to produce seeds for feed that may maximize cheese production of cows or enhance the quality of cheese. The computing device 130 may select germination Recipe Z for the cows producing cream. Recipe Z may be predetermined to produce seeds for feed that may maximize cream production of cows or enhance the quality of cream.

While FIG. 5 depicts the production cycle is divided into four phases, the production cycle may be divided into more than or less than four phases. For example, the production cycle may be divided into fourteen phases corresponding to fourteen months. Each of the fourteen phases is assigned a different germination recipe that is predetermined to maximize milk production of cows in the corresponding phase.

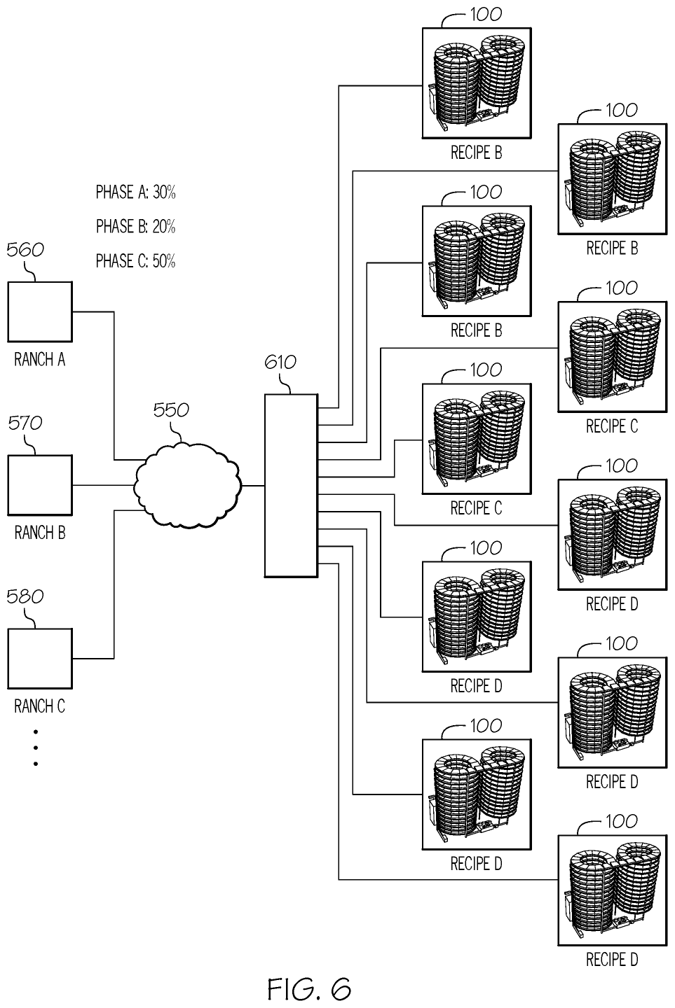

FIG. 6 depicts operating a plurality of assembly line grow pods according to germination recipes determined based on information about status of animals, according to one or more embodiments shown and described herein.

In embodiments, a plurality of computing devices for a plurality of ranches communicate with a plurality of assembly line grow pods. For example, the computing device 560 for ranch A, a computing device 570 for ranch B, a computing device 580 for ranch C, etc. communicate information about the status of animals in their ranches to a controller 610 via the network 550. The controller 610 may receive information about the status of animals and determine a ratio of animals in different phases of production cycle. For example, the controller 610 may receive information about the status of animals in Ranch A, Ranch B, Ranch C, etc., and determine that 30% of cows in the ranches are in Phase A, 20% of cows in the ranches are in Phase B, and 50% of cows in the ranches are in Phase C.

In embodiments, the controller 610 may determine a ratio of Recipe B, Recipe C, and Recipe D which maximize milk production of cows in Phase A, cows in Phase B, and cows in Phase C, respectively, and allocate germination recipes among a plurality of assembly line grow pods. For example, the controller 610 determines that ratio of Recipe B, Recipe C, and Recipe D is 3:2:5, and instruct three of 10 assembly line grow pods to operate according to germination Recipe B, two of 10 assembly line grow pods to operate according to germination Recipe C, five of 10 assembly line grow pods to operate according to germination Recipe D as shown in FIG. 6. In some embodiments, the controller 610 may instruct each of 10 assembly line grow pods to operate according to Recipe B for 30% of entire operation time, instruct each of 10 assembly line grow pods to operate according to Recipe C for 20% of entire operation time, and instruct each of 10 assembly line grow pods to operate according to Recipe D for 50% of entire operation time.

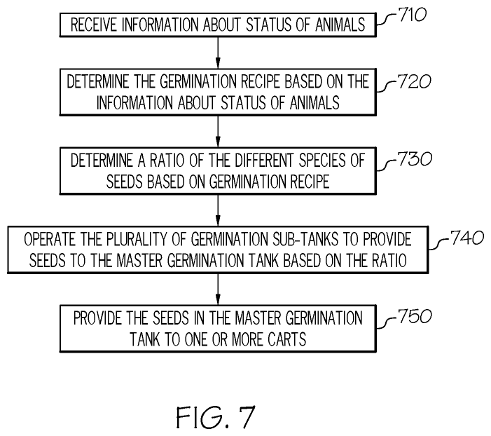

FIG. 7 depicts a flowchart for germinating seeds according to a germination recipe, according to one or more embodiments shown and described herein.

In step 710, the computing device 130 receives information about status of animals. In embodiments, the computing device 130 receives information about status of animals from the user computing device 552 as shown in FIG. 3. For example, a user may input status of animals including their current production phase, health status, weights, etc. In some embodiments, the computing device 130 may receive information about status of animals from a computing device configured to collect information about the animals. For example, the computing device 130 may receive information about status of animals from the computing device 560 configured to collect information about animals in the ranch 562.

In step 720, the computing device 130 determines the germination recipe based on the information about status of animals. In embodiments, the computing device 130 may receive information about a current production phase to which the animals belong, and determine a germination recipe based on the current production phase. For example, as described above with reference to FIG. 4, 30 cows are in phase A, and 20 cows are in phase B, 40 cows are in phase C, and 0 cows in phase D. Then, with reference to Table 2, the computing device 130 controls the germination system to germinate seeds according to Recipe B, germinate seeds according to Recipe C, and germinate seeds according to Recipe D. The ratio of seeds germinated according to Recipe B, seeds germinated according to Recipe C, and seeds germinated according to Recipe D may be 3:2:4 based on the ratio of the number of cows in phases A, B, and C. For example, the germination system 200 may germinate seeds according to Recipe B that may be provided to 300 industrial carts, germinate seeds according to Recipe C that may be provided to 200 industrial carts, and germinate seeds according to Recipe D that may be provided to 400 industrial carts.

In step 730, the computing device 130 determines a ratio of the different species of seeds based on the germination recipe. In embodiments, the germination recipe includes a ratio of different species of seeds. For example, by referring to Table 1 above, if Recipe B is determined as the germination recipe, the computing device 130 determines that the ratio of barley, pea, and wheat is 3:3:4 according to Recipe B.

In step 740, the computing device 130 operates the plurality of germination sub-tanks to provide seeds to the master germination tank based on the ratio. In embodiments, the computing device 130 operates the germination sub-tanks 212, 214, and 216 to provide seeds in their tanks to the master germination tank based on the ratio. For example, the germination sub-tank 212 stores barley seeds, the germination sub-tank 214 stores pea seeds, and the germination sub-tank 216 stores wheat seeds, and the computing device 130 operates the germination sub-tanks 212, 214, and 216 to provide seeds in the ratio of 3:3:4. The master germination tank 220 receives the seeds from the germination sub-tanks 212, 214, and 216 and mixes the seeds by providing water and air into the master germination tank 220.

In step 750, the computing device 130 provides the seeds in the master germination tank to one or more carts. In embodiments, the computing device 130 instructs the master germination tank 220 to provide seeds to the seeder component 108, and instructs the seeder component 108 to provide the seeds to the industrial carts 104, for example, as shown in FIG. 2. Each of the industrial cart may receive seeds and go through the entire track 102 of the assembly line grow pod 100. It may take about 144 hours to 168 hours for the seeds to grow on the industrial cart before being harvested by the harvesting component of the assembly line grow pod 100. Each of the industrial carts carries seeds germinated according to a specific germination recipe. For example, as shown in FIG. 2, the industrial carts 104-1, 104-2, and 104-3 carry seeds germinated according to Recipe A and the industrial cart 104-N carries seeds germinated according to Recipe B. The computing device 130 may store information about nutrition levels of plants harvested from each of the industrial carts 104. For example, when plants in the industrial cart 104-1 in FIG. 2 are harvested, the computing device 130 determines that the harvested plants have 15% of fiber, 31% of protein, and 5% of carbohydrates based on germination Recipe A. The nutrition level information may be assigned to a package containing the harvested plants. The computing device 130 may transmit the nutrition level information about the harvested plants to the user computing device 552, the remote computing device 554, and/or the computing device 560 at the ranch.

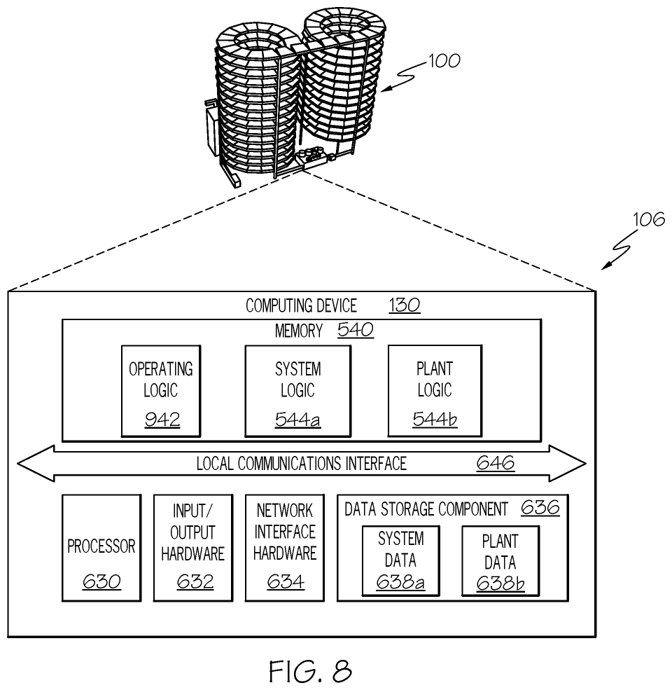

FIG. 8 depicts a master controller 106 for an assembly line grow pod 100, according to embodiments described herein. As illustrated, the master controller 106 includes a processor 630, input/output hardware 632, the network interface hardware 634, a data storage component 636 (which stores systems data 638a, plant data 638b, and/or other data), and the memory component 540. The memory component 540 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the master controller 106 and/or external to the master controller 106.

The memory component 540 may store operating logic 642, the systems logic 544a, and the plant logic 544b. The systems logic 544a and the plant logic 544b may each include a plurality of different pieces of logic, each of which may be embodied as a computer program, firmware, and/or hardware, as an example. A local communications interface 646 is also included in FIG. 8 and may be implemented as a bus or other communication interface to facilitate communication among the components of the master controller 106.

The processor 630 may include any processing component operable to receive and execute instructions (such as from a data storage component 636 and/or the memory component 540). The input/output hardware 632 may include and/or be configured to interface with microphones, speakers, a display, and/or other hardware.

The network interface hardware 634 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the master controller 106 and other computing devices, such as the user computing device 552 and/or remote computing device 554.

The operating logic 642 may include an operating system and/or other software for managing components of the master controller 106. As also discussed above, systems logic 544a and the plant logic 544b may reside in the memory component 540 and may be configured to performer the functionality, as described herein.

It should be understood that while the components in FIG. 8 are illustrated as residing within the master controller 106, this is merely an example. In some embodiments, one or more of the components may reside external to the master controller 106. It should also be understood that, while the master controller 106 is illustrated as a single device, this is also merely an example. In some embodiments, the systems logic 544a and the plant logic 544b may reside on different computing devices. As an example, one or more of the functionalities and/or components described herein may be provided by the user computing device 552 and/or remote computing device 554.

Additionally, while the master controller 106 is illustrated with the systems logic 544a and the plant logic 544b as separate logical components, this is also an example. In some embodiments, a single piece of logic (and/or or several linked modules) may cause the master controller 106 to provide the described functionality.

As illustrated above, various embodiments for germinating seeds according to a germination recipe are disclosed. A system for germinating seeds for a grow pod includes a plurality of germination sub-tanks configured to receive seeds, the plurality of germination sub-tanks receiving different species of seeds, respectively, a master germination tank configured to receive seeds from one or more of the plurality of germination sub-tanks, and a controller. The controller includes one or more processors, one or more memory modules storing germination recipes, and machine readable instructions stored in the one or more memory modules that, when executed by the one or more processors, cause the controller to: determine a ratio of the different species of seeds based on a germination recipe, operate the plurality of germination sub-tanks to provide seeds to the master germination tank based on the ratio, and provide the seeds in the master germination tank to one or more carts.

These embodiments produce plants having customized nutrition levels based on germination recipes. The germination recipe may be determined based on required nutrition levels input by a user or information about status of animals to feed. The germination recipe may be implemented strictly and/or modified based on results of a particular plant, tray, or crop.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein includes systems, methods, and non-transitory computer-readable mediums for germinating seeds for an assembly line grow pod. It should also be understood that these embodiments are merely exemplary and are not intended to limit the scope of this disclosure.

What is claimed is:

1. A system for germinating seeds for a grow pod, the system comprising:
a plurality of germination sub-tanks configured to receive seeds, the plurality of germination sub-tanks receiving different species of seeds, respectively;
a master germination tank configured to receive seeds from one or more of the plurality of germination sub-tanks; and
a controller comprising:
one or more processors;
one or more memory modules storing germination recipes; and
machine readable instructions stored in the one or more memory modules that, when executed by the one or more processors, cause the controller to:
determine a ratio of the different species of seeds based on a germination recipe;
operate the plurality of germination sub-tanks to provide seeds to the master germination tank based on the ratio; and
provide the seeds in the master germination tank to one or more carts.

2. The system of claim 1, wherein the machine readable instructions stored in the one or more memory modules, when executed by the one or more processors, cause the controller to:
receive information about status of animals; and
determine the germination recipe based on the information about status of animals.

3. The system of claim 2, wherein information about status of animals includes information about production cycle of the animals.

4. The system of claim 2, wherein the machine readable instructions stored in the one or more memory modules that, when executed by the one or more processors, cause the controller to:
receive the information about the status of animals from sensors attached to the animals.

5. The system of claim 1, further comprising:
an input device configured to receive nutrition levels,
wherein the machine readable instructions stored in the one or more memory modules, when executed by the one or more processors, cause the controller to determine the germination recipe based on the received nutrition levels.

6. The system of claim 1, wherein the germination recipe includes a ratio of the different species of seeds in association with nutrition levels.

7. The system of claim 6, wherein the nutrition levels include at least one of a fiber level or a protein level.

8. The system of claim 1, wherein the different species of seeds include at least one of barleys, peas, wheats, and clovers.

9. The system of claim 1, wherein a first species of seeds are poured into one of the plurality of germination sub-tanks a predetermined time before a second species of seeds are poured into another of the plurality of germination sub-tanks, and the predetermined time is set based on a germination time for the first species of seeds and a germination time for the second species of seeds.

10. The system of claim 1, further comprising:
a conveyor configured to move seeds from a plurality of silos to the plurality of germination sub-tanks.

11. A controller for germinating seeds for a grow pod, the controller comprising:
one or more processors;
one or more memory modules storing germination recipes; and
machine readable instructions stored in the one or more memory modules that, when executed by the one or more processors, cause the controller to:
determine a ratio of the different species of seeds based on a germination recipe;
operate a plurality of germination sub-tanks to provide seeds to a master germination tank based on the ratio; and
provide the seeds in the master germination tank to one or more carts,
wherein the plurality of germination sub-tanks receive different species of seeds, respectively.

12. The controller of claim 11, wherein the machine readable instructions stored in the one or more memory modules, when executed by the one or more processors, cause the controller to:
receive information about status of animals; and
determine the germination recipe based on the information about status of animals.

13. The controller of claim 12, wherein information about status of animals includes information about production cycle of the animals.

14. The controller of claim 11, wherein the germination recipe includes a ratio of the different species of seeds in association with nutrition levels.

15. The controller of claim 11, wherein a first species of seeds are poured into one of the plurality of germination sub-tanks a predetermined time before a second species of seeds are poured into another of the plurality of germination sub-tanks, and the predetermined time is set based on a germination time for the first species of seeds and a germination time for the second species of seeds.

16. A method for germinating seeds for a grow pod, the method comprising:
providing different species of seeds to a plurality of germination sub-tanks, respectively;
determining a ratio of the different species of seeds based on a germination recipe;
operating the plurality of germination sub-tanks to provide the different species of seeds to a master germination tank based on the ratio; and
providing the seeds in the master germination tank to one or more carts.

17. The method of claim 16, further comprising:
receiving information about status of animals; and
determining the germination recipe based on the information about status of animals.

18. The method of claim 17, wherein information about status of animals includes information about production cycle of the animals.

19. The method of claim 16, wherein the germination recipe includes a ratio of the different species of seeds in association with nutrition levels.

20. The method of claim 16, wherein a first species of seeds are poured into one of the plurality of germination sub-tanks a predetermined time before a second species of seeds are poured into another of the plurality of germination sub-tanks, and the predetermined time is set based on a germination time for the first species of seeds and a germination time for the second species of seeds.
